(19) United States
(12) Patent Application Publication
(10) Pub. No.: US 2025/0186950 A1
(43) Pub. Date: Jun. 12, 2025

(54) PROCESSES FOR THE PREPARATION OF POLYMERIC MEMBRANES CONTAINING IONIC LIQUIDS AND THEIR DERIVATIVES FOR THE SEQUESTRATION OF CO2 FROM NATURAL GAS BY GASEOUS PERMEATION AND POLYMERIC MEMBRANES OBTAINED BY THESE PROCESSES

(71) Applicants: PETRÓLEO BRASILEIRO S.A. - PETROBRAS, Rio de Janeiro (BR); UNIVERSIDADE FEDERAL DO RIO DE JANEIRO - UFRJ, Rio de Janeiro (BR)

(72) Inventors: FREDERICO DE ARAÚJO KRONEMBERGER, Rio de Janeiro (BR); FERNANDO GUSMAN BRANDAO, Rio de Janeiro (BR); AMANDA LORETI HUPSEL, Rio de Janeiro (BR); LEONARDO DOS SANTOS PEREIRA, Rio de Janeiro (BR); DARLEY CARRIJO DE MELO, Rio de Janeiro (BR); CRISTIANO PIACSEK BORGES, Rio de Janeiro (BR); ALBERTO CLAUDIO HABERT, Rio de Janeiro (BR)

(73) Assignees: PETRÓLEO BRASILEIRO S.A. - PETROBRAS, Rio de Janeiro (BR); UNIVERSIDADE FEDERAL DO RIO DE JANEIRO - UFRJ, Rio de Janeiro (BR)

(21) Appl. No.: 18/972,245

(22) Filed: Dec. 6, 2024

(30) Foreign Application Priority Data
Dec. 6, 2023 (BR) 1020230256597

(51) Int. Cl. B01D 67/00; B01D 53/22; B01D 69/02; B01D 69/06; B01D 69/10; B01D 69/12; B01D 71/34; B01D 71/38; B01D 71/80; C10L 3/10

(52) U.S. Cl. CPC B01D 67/00091; B01D 53/228; B01D 69/02; B01D 69/06; B01D 69/107; B01D 69/1214; B01D 71/34; B01D 71/381; B01D 71/80; C10L 3/104; B01D 2256/245; B01D 2257/504; B01D 2323/10; B01D 2323/226; B01D 2323/30; B01D 2325/023

(57) ABSTRACT

The present invention refers to processes for the preparation of polymeric membranes, which can be nanostructured hybrids, containing ionic liquids and their derivatives for sequestration of CO₂ from natural gas by gaseous permeation, and its referred membranes. The membranes of the present invention can be dense flat membranes, or composite asymmetric flat membranes. The invention can be applied in oil and gas extraction and renewable energies, for example, in existing gas treatment plants on off-shore platforms, replacing existing conventional polymeric membranes, as well as in new gas treatment plant designs that use polymeric membranes as natural gas purification technology, or treatment of exhausted gas streams.

### CROSS-REFERENCE FOR RELATED APPLICATIONS

This application claims priority to Brazilian Application No. BR 1020230256597, filed on Dec. 6, 2023, the disclosure of which is herein incorporated by reference in the entirety.

### FIELD OF THE INVENTION

The present invention refers to processes for the preparation of polymeric membranes, which can be nanostructured hybrids, containing ionic liquids and their derivatives for sequestration of CO₂ from natural gas by gaseous permeation, and its referred membranes. The membranes of the present invention can be dense flat membranes, or composite asymmetric flat membranes.

The invention can be applied in oil and gas extraction and renewable energies, for example, in existing gas treatment plants on off-shore platforms, replacing existing conventional polymeric membranes, as well as in new gas treatment plant designs that use polymeric membranes as natural gas purification technology, or treatment of exhausted gas streams.

### BACKGROUND OF THE INVENTION

Natural gas extracted from underwater deposits off the Brazilian coast contains high levels of CO₂ (15-50% by volume), which needs to be separated from the main stream to ensure the thermal power conferred by methane CH₄, the main component, in order to meet the current standards for its use as fuel and feedstock in the petrochemical industry. In addition, this natural gas is available at relatively high pressures. The most widely used technology employs chemical extraction of CO₂ and operates at low pressures, also requiring thermal recovery of absorbent solvents, making the process energetically costly. The most promising alternative process for purifying natural gas lies in the process of gaseous permeation, which employs selective polymeric membranes. However, this process has performance limitations that affect the operation and economics of the extraction process, when the concentration of CO₂ increases in natural gas.

Considering that the limitations mentioned above could be circumvented if more efficient membranes were used in gaseous permeation, also promoting the reduction of the space occupied by the industrial unit and the increase of methane recovery (volume of natural gas enriched with CH₄), the technical problem to be solved by the present invention is to extract the CO₂ present in natural gas more effectively.

Thus, the objective of the present invention was the development of polymeric membranes that are more selective to CO₂ to be used in natural gas purification processes that have high concentrations of CO₂. The membranes developed are polymeric membranes containing ionic liquid in their composition that can be used in existing natural gas treatment plants, replacing conventional polymeric membranes.

Due to its better performance, the adoption of this new membrane has the potential to reduce the area and weight occupied on offshore platforms, or even allow a greater flow of gas to be treated by the plant. This technology can also be applied to capture CO₂ in exhausted gas streams from turbines and other sources as a way to reduce the emission of polluting gases into the atmosphere.

The polymeric membranes obtained by the processes of this invention withstand high operating pressures, and have been tested to extract CO₂ present in natural gas at high concentrations, particularly up to 50%.

### BACKGROUND OF THE INVENTION

The sequestration of CO₂ from hydrocarbon streams, in particular natural gas, remains an important priority for the oil and gas industry. Processes that use selective membranes are considered one of the most promising alternatives to replace conventional treatment with amines. Membrane processes have several advantages, such as smaller installation space and lower energy requirements, in addition to not requiring regeneration of extractors or adsorbents. Challenges still persist in relation to the performance of the membranes currently available on the market, particularly in the sense of obtaining a good compromise between permeability and selectivity.

Several studies have shown that the selectivity of membranes decreases as permeability to the more permeable gaseous component increases. A correlation of permeability and selectivity originally suggested by Robeson has updated the literature outcomes for each gaseous mixture of industrial interest, indicating the best membrane performance values to be overcome, graphically represented by a straight line in the permeability vs. selectivity diagram and known as “Robeson upper limit”. Thus, it serves as a guide to develop membranes that have high permeabilities and selectivities to be used in industrial processes, in an economically viable way. Despite the wide availability of developed materials, few could be commercially incorporated into the market for capturing CO₂ from gas mixtures.

Ionic liquids (IL) are materials that have a unique combination of physicochemical properties, in addition to some being good solvents for CO₂, and have recently been suggested as promising components in the manufacture of membranes that can reach or exceed the Robeson upper limit for mixtures containing CO₂. Thus, membranes containing ionic liquids can achieve performances superior to membranes currently available on the market. However, the incorporation of these membranes in the market is still restricted by the high cost and the difficult production of ionic liquids.

Some protic ionic liquids, based on ethanolamines and carboxylic acids, also show high absorptive selectivities for CO₂compared to CH₄, also showing reversible interactions with CO₂. These materials can be synthesized through a simple and inexpensive route, evidencing their potential for application in the separation between CO₂ and CH₄. The impregnation of a protic ionic liquid in polymeric materials of lower cost and adequate chemical and mechanical properties could generate membranes with excellent performance in the treatment of natural gas.

In addition to the difficulty of incorporating ionic liquids into polymers for the production of membranes, there are also major limitations in scaling these membranes from the laboratory to the industrial scale. This is due to factors such as the low availability of data obtained in operations with industrial mixtures, conducted at high pressures, and the performance of temporal stability tests, in addition to, above all, the difficulty of producing membranes and permeation modules in commercial format. The format necessary to generate greater performance for the commercialization of the product comprises the production of composite membranes, which have a porous support covered with a dense selective thin layer, generated from the developed polymeric solution. The production of this type of membrane involves a series of technical difficulties to generate a selective layer thin enough and for the resulting membrane to have high performance associated with an economically acceptable useful life.

The state of the art document WO 2021/219887 refers to a composite membrane for gas separation, which is suitable for separating a gas from a gas mixture and comprises a selective layer coated on a support, in which said selective layer comprises: a) a polymeric matrix comprising an amine polymer; b) a graphene oxide nanoload and c) a mobile transporter selected from an ionic liquid or an amino acid salt, as well as proposes a process for the formation of said membrane. Both the components of the membrane and the process suggested by WO 2021/219887 differ from those proposed here.

In this context, the present invention is based on the formulation of a protic ionic liquid in a suitable polymeric material. The solution generated in this mixture is used in the coating of a porous support for the production of composite membranes, aiming at high performance and stability, to be used in the removal of CO₂ from crude gas streams on an off-shore oil platform, under more severe operating conditions, dictated by pressure and composition of the gas stream to be treated.

### SUMMARY OF THE INVENTION

The present invention aims to study a process or manufacturing techniques for the production of new nanostructured membranes containing ionic liquids and their derivatives for sequestration of CO₂ from natural gas by gaseous permeation.

The invention carried out made it possible to obtain polymeric membranes that are more selective to CO₂ (carbon dioxide) in relation to CH₄ (methane) through the impregnation of polymers (such as PVA and PEBAX®) with ionic liquids (such as protics based on N-methylethanolamine, using various manufacturing techniques). These membranes withstand high operating pressures (currently up to 50 bar) and extract CO₂ from methane mixtures containing a content between 10%-50% CO₂. The membranes are stable over time, maintaining in addition to the permeability-selectivity binomial, their physicochemical and mechanical properties.

Polymers sold as PEBAX® are thermoplastic elastomers, more specifically amide/polyether copolymers.

As general and specific advantages configured by this invention, it is notorious that membrane separation processes present an excellent alternative to conventional separation systems and methods that have greater weights, volumes and areas of occupation, in addition to higher operating costs. These are processes that do not involve phase change and are therefore more cost-effective in terms of the energy required. In addition, membrane separation processes minimize environmental impacts, respecting current standards/legislation, due to the absence of chemicals and tailings generated in the process.

In addition, membrane separation processes can be easily integrated into other units/processes already in operation, and the equipment used in membrane separation processes is compact and modular, suitable for system scaling, as well as easy to install and maintain.

The production of polymeric membranes does not present high costs and technical difficulties on a laboratory scale.

Protic ionic liquids based on N-methylethanolamine are additives capable of considerably increasing the performance of polymeric membranes without loss of mechanical properties, with ease and lower production cost compared to other ionic liquids.

The technique of spraying polymeric solutions under a substrate explored here allows the manufacture of flat composite membranes, of the type found in commercial membranes, with thin selective layers and high performance, with versatility and possibility of application with various polymers and supports.

Polymeric membranes containing protic ionic liquids based on N-methylethanolamine can have high performance and replace the current commercial membranes, representing savings in the area of membrane used as well as in the productivity of the natural gas enrichment process.

### BRIEF DESCRIPTION OF THE FIGURES

The patent or application file contains at least one drawing executed in color. Copies of this patent or patent application publication with color drawing(s) will be provided by the Office upon request and payment of the necessary fee.

To facilitate an easier understanding of the invention, Figures numbered 1-11 are provided for illustrative purposes, but without the intention of limiting the invention. These figures accompany this specification and are an integral part of it.

FIG. 1 illustrates the production process of dense PVAR_LI and PB_LI membranes (images 1.1, 1.2 and 1.3) and the permeation tests on pure gases performed only with these membranes (flowchart represented in the fourth image, 1.4).

FIG. 2 illustrates the preparation of composite membranes.

FIG. 3 comprises photomicrographs of the surface (3A), cross-section (3B) and enlarged cross-section (3C) of the DUR_PB_LI composite membrane.

FIG. 4 refers to photomicrographs of the surface (4A), cross-section (4B), and enlarged cross-section (4C) of the PVDF_PB_LI_1 composite membrane.

FIG. 5 refers to the flowchart of the high-pressure system used for permeation experiments with gas mixtures.

FIG. 6 shows the results of permeation with pure gases at 6 bar for the dense membranes, obtained in the benchtop system.

FIG. 7 discloses the performance of the different composite membranes produced in comparison with the performance of a commercial membrane, in permeation experiments in the high-pressure system at a pressure of 30 bar, with mixtures of different compositions in the feed, and with pure CO₂ gas, at a pressure of 2 bar.

FIG. 8 refers to the lifespan experiment of the DUR_PB_LI membrane, with a continuous feed of a 70/30 CH₄/CO₂ gas mixture at a pressure of 10 bar, and a pressure of 40 bar at the time of measurement.

FIG. 9 refers to the lifespan experiment of the PVDF_PB_LI_2 membrane, with a continuous feed of a 70/30 CH₄/CO₂ gas mixture at a pressure of 10 bar, and a pressure of 40 bar at the time of measurement.

FIG. 10 demonstrates the characterization of the material composition by FTIR of Example 6, by Fourier transform infrared spectroscopy (FTIR) of the pure PVA membrane and the membrane containing PVA_LI ionic liquid.

FIG. 11 demonstrates the characterization of the material composition by FTIR of Example 7, by Fourier transform infrared spectroscopy (FTIR) of the pure amide/polyether copolymer membrane and the membrane containing PB_LI ionic liquid.

### DETAILED DESCRIPTION OF THE INVENTION

The present invention describes a process or techniques for the preparation of polymeric membranes, which can be nanostructured hybrids, containing ionic liquids (IL) and their derivatives for sequestration of CO₂ from natural gas by gaseous permeation, and its referred membranes. The membranes of the present invention can be dense flat membranes, or composite asymmetric flat membranes.

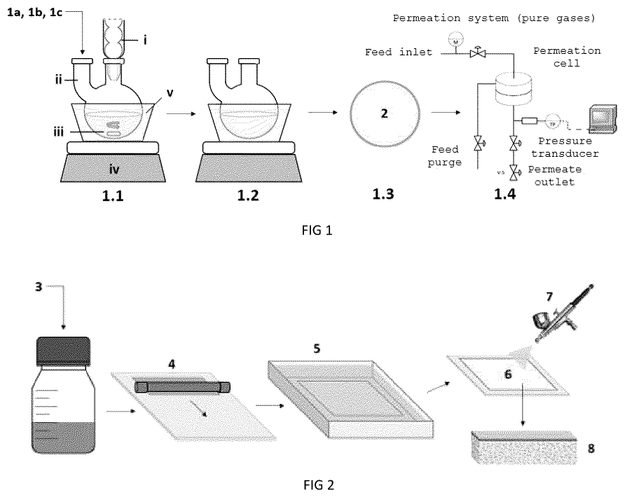

In an embodiment, the present invention aims at a process for the preparation of a flat dense polymeric membrane, which comprises the steps of:
(a) dissolution of a polymer (items 1a, 1b, in FIG. 1) in a suitable solvent;
(b) addition of the protic ionic liquid (IL) (item 1c, in FIG. 1) based on N-methylethanolamine (NMEA); and
(c) evaluation of the transport properties of the polymers and the effect of the addition of IL through the production of flat dense membranes (2) generated from the controlled evaporation of the solvent from polymeric solutions in a container made of inert material.

In another embodiment, the present invention also aims at a process of preparation of a polymeric, asymmetric flat composite membrane, which comprises the steps of:
(a) dissolution of a polymer (1a, 1b) in a suitable solvent;
(b) addition of the protic ionic liquid (IL) (1c) based on N-methylethanolamine (NMEA);
(c) dissolution of the polymeric solution produced in step (a) up to a range between 0.2 and 1% w/w of polymer mass in the solution, and removal of the air dissolved in the solution by ultrasound;
(d) dissolution of a polymer suitable for the production of porous membranes with the desired characteristics for use as a support for polymeric solutions containing IL, followed by spreading it with an extensometer on a glass support and subsequent immersion in a non-solvent bath for polymer precipitation;
(e) addition of the polymeric solution to a pressurized apparatus capable of generating membranes, followed by pressurization in a range of 20-40 psi on a porous polymeric support, which can be a commercial membrane or a membrane produced in step (e); and
(f) coating of the selective layer of the composite membrane with a solution of super permeable silicone elastomeric polymer in order to cover any defects and promote the protection of the membrane for manipulation.

Preferably, a process of the present invention, as described above, of preparation of a flat dense polymeric membrane or of preparation of a polymeric, asymmetric flat composite membrane, may additionally comprise a crosslinking reaction for stabilization of a polymer (1a) when required. In this case, such an optional step (b′) occurs after the addition of the protic ionic liquid (1c), before the next step.

According to the present invention, polymer (1a) can be selected from polymer for the production of polymeric solutions (PVA, glutaraldehyde). Meanwhile, polymer (1b) can be selected from polymer for the production of amide/polyether copolymer polymeric solutions.

Regardless of the type of process of the present invention, whether it is aimed at the preparation of a flat dense polymeric membrane or the preparation of a polymeric, asymmetric flat composite membrane, in step (a), the solvent used is in a range of about 3 to about 7% w/w.

According to the processes of the present invention, the protic ionic liquid (IL) (1c) can be selected from protic ionic liquid based on N-methylethanolamine ([m−2-HEA][Pr]). In step (b) of the processes according to the present invention, the mentioned protic ionic liquid (IL) (1c) based on N-methylethanolamine (NMEA) can be added in ratios ranging from 60 to 80% w/w of the polymer mass in the solution.

The polymer solution plus the IL is arranged in an inert coated base for slow evaporation of the solvent and generation of the dense membrane, preferably a flat dense polymeric membrane (item 2, in FIG. 1), preferably of cross-linked PVA or an amide/polyether copolymer impregnated with the ionic liquid [m-2-HEA][Pr], and the transport properties in pure gases of which are evaluated in a bench-scale system (see FIG. 1).

The addition of an IL that is selective to CO₂, and has low interaction with CH₄, aims to improve the performance of membranes, increasing their permeability to CO₂ without also increasing the permeability to CH₄, aiming to increase productivity in natural gas processing. For the membrane to be stable, the IL must be compatible with the polymeric matrix used, and for the proposed ionic liquids, it is ideal to use polymers that have polar groups.

According to a process of this invention, dense membranes are obtained and the properties of these dense membranes are evaluated. The polymeric solutions produced are then used as a selective layer to coat a commercially available porous support, such as a support membrane (commercial/PVDF) used for the production of flat composite membranes. The porous support must be a partially hydrophobic membrane with porosity in the microfiltration and ultrafiltration ranges, and commercial membranes or membranes produced with the appropriate characteristics may be used.

A porous membrane suitable for use as a support can be produced using the phase inversion method, which consists of dissolving a polymer in a suitable solvent, e.g., a polymeric solution (PVDF (polyvinylidene fluoride), NMP (N-methyl-2-pyrrolidone), adipic acid), followed by spreading this polymeric solution with a controlled thickness extensometer over an inert surface, and ending with the precipitation of this polymer in a non-solvent bath, such as pure water.

The production of composite membranes can be accomplished by various available techniques, including the spray or misting technique. The deposition of polymeric solutions containing the ionic liquid N-methyl-2-hydroxyethylammonium propionate ([m-2-HEA][Pr]) on the supports can be conducted with the use of paint guns or airbrushes, which allow the obtaining of thin and homogeneous selective layers, enabling the manufacture of membranes with high performance and mechanical strength. The composite membranes obtained, typically those containing a selective layer (PB_LI) sprayed on a porous support, can have an additional coating, also by the misting technique, using polymeric solutions of ultra-permeable silicone elastomers, which eliminate the inconvenience of eventual failures and defects on the surface of the selective layer, thus increasing the membrane selectivity.

Preferably, when the protic ionic liquid used is based on N-methylethanolamine, it is used in ratios ranging from about 60 to about 80% w/w of the polymer mass in the solution.

Preferably, the flat dense membranes (item 2, in FIG. 1) generated by the process of preparing a polymeric membrane of the present invention are flat dense polymeric membranes of cross-linked PVA or amide/polyether copolymer impregnated with the ionic liquid [m-2-HEA][Pr].

### EXAMPLES AND RESULTS

Two dense membranes were manufactured from two different polymers containing a protic ionic liquid based on N-methylethanolamine. The performance of the membranes was evaluated to determine their permeability properties (barrer) and actual selectivity.

The tests were conducted on a bench scale using a system similar to the schematic representation in FIG. 1, consisting of pure gas cylinders in line, with a pressure regulator at the feed. Different experiments are required to evaluate the transport properties for different gases. The flat membranes are deposited in a stainless steel chamber. The feed pressure is increased by initiating the process of gaseous permeation. The permeate gas flow over time is obtained by means of a Datalogger pressure transducer, located in the permeate chamber. This experiment allows obtaining the parameters of (ideal) permeability and selectivity of dense membranes.

Two composite membranes were produced from the PB_LI solution, with higher permeability, using the misting method described in FIG. 2. The membranes were produced in a commercial polymeric support or a polymeric support produced as shown in FIG. 2 by phase inversion method. The tests were conducted on a bench scale using a system similar to the schematic representation in FIG. 5. The operation of the system occurs similarly to that described for the experiments carried out for dense membranes. However, in this system, cylinders containing gas mixtures at high pressures are used. The properties of permeance (GPU) and actual selectivity are obtained. The gas contained in the permeate chamber is directed to an in-line mass spectrometer, allowing continuous monitoring of the permeate composition. From the partial pressure of each gas in the feed and in the composition obtained by the mass spectrometer, it is possible to determine the (real) selectivity of the tested membrane for the mixture.

The permeability (p—in Barrer) is determined from the change in pressure as a function of time in the permeate chamber of volume known through Eq. 1.

$$p = \frac{dP}{dt} . ( \frac{{V}_{sistema}}{A . Δ P} ) . ( \frac{{T}_{CNTP}}{T . {P}_{CNTP}} ) . L \qquad Eq . 1$$

Where:
dp/dt—Pressure variation as a function of time (cmHg/s);
Vp—Volume of permeate chamber (cm³);
Am—Permeation area (cm²);
PA—Feed pressure (cmHg);
TNTP—Temperature under NTP conditions (293.15 K);
PNTP—Pressure under NTP conditions (76 cmHg);
Tamb—Room temperature (298 K);
L—Thickness (μm).

The permeance (in GPU) is calculated by Eq. 1 without multiplying by the thickness term and is applied in the calculation for composite membranes. Selectivity can be calculated as the ratio of the permeability of the more permeable gas i to the less permeable gas j, using Eq. 2. When the permeability of pure gases is employed, S is defined as optimal selectivity. When the permeabilities of gases in

$$S = \frac{{P}_{i}}{{P}_{j}}$$

mixtures are used, S represents the actual selectivity.

Where:
Pi—Permeability of the most permeable gas (Barrer or GPU); and
Pi—Permeability of the less permeable gas (Barrer or GPU)

### EXAMPLES

### Example 1

A flat dense membrane identified as PVAR_LI was manufactured as per FIG. 1. A polymeric solution was prepared with a concentration of polyvinyl alcohol (PVA) (1a) of 7% w/w as a base polymer in pure water 93% w/w as a solvent. The reagents were mixed under magnetic stirring and heating until homogenization of the polymeric solution, under reflux conditions.

Then, propionic acid is added to adjust the pH up to 5 and a crosslinking agent, which can be glutaraldehyde, in a ratio of 0.1% w/w of the polymer mass in the solution. After 10 minutes of reaction, a protic ionic liquid (IL) based on N-methylethanolamine is added, in this case N-methyl-2-hydroxyethylammonium propionate ([m-2-HEA][Pr]) (1c), in a ratio of 80% w/w of the polymer mass in the solution. The pH is readjusted to 5 and stirring is maintained until the end of the reaction for 60 minutes. The synthesis of the pure membrane (called PVA) as the basis of comparison is carried out without the addition of the ionic liquid. The solutions produced are left to rest to remove air bubbles and poured onto a covered neutral base for slow evaporation of the solvent and formation of dense membranes (2).

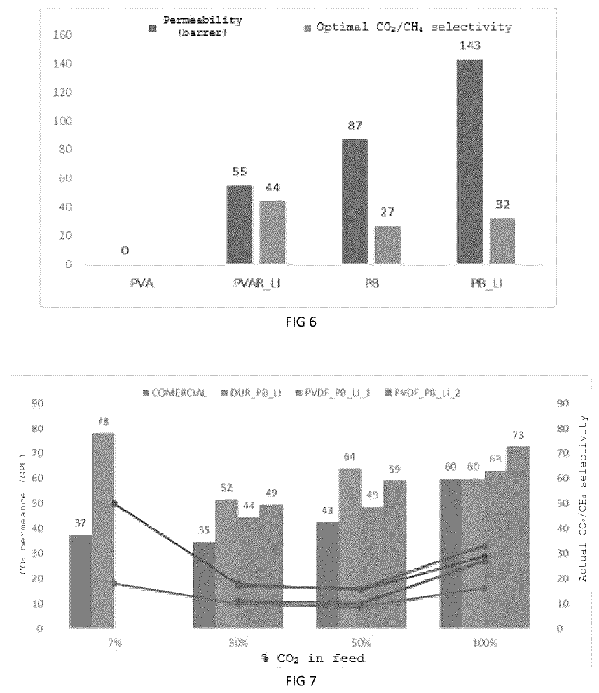

Permeation tests were performed with pure gases CO₂ and CH₄ separately at a pressure of 6 bar. The membranes showed a permeability of about 55 barrer and optimal selectivity CO₂/CH₄ of 44, much higher than the transport properties of pure polymer (PVA), which did not show permeation for either gas (barrier properties) (FIG. 6). The PVAR_LI membrane remained stable during alternating permeation cycles of CO₂ and CH₄ continuously applied at a pressure of 6 bar over a period of 1 month.

### Example 2

A flat dense membrane identified as PB_LI was manufactured as per FIG. 1. A polymeric solution was prepared with a concentration of poly(ethylene oxide-b-amide-6) (PEBA), Pebax® MH 1657 grade (amide/polyether copolymer) (1b), of 3% w/w as a base polymer in a mixture of 30% w/w pure water and 70% w/w absolute ethanol, as solvent. The reagents were mixed under magnetic stirring and heating until homogenization of the polymeric solution, under reflux conditions.

Then, a protic ionic liquid based on N-methylethanolamine, in this case [m-2-HEA][Pr](1c), is added in a ratio of 60% w/w of the polymer mass in the solution, and stirring is maintained for 60 minutes at room temperature. The synthesis of the pure membrane (called PB) as the basis of comparison is carried out without the addition of the ionic liquid. The solutions produced are left to rest to remove air bubbles and poured onto a covered neutral base for slow evaporation of the solvent and formation of dense membranes (2).

The permeation tests were performed with pure gases CO₂ and CH₄ separately at a pressure of 6 bar, in the system represented in FIG. 1. The membranes showed a permeability of about 143 barrer and optimal selectivity CO₂/CH₄ of 32, much higher than the transport properties of pure polymer (PB), whose permeability was 87 and optimal selectivity CO₂/CH₄ of 27. The addition of IL generated a 64% increase in permeability and a 19% increase in pure polymer selectivity (FIG. 6). The PB_LI membrane remained stable during alternating permeation cycles of CO₂ and CH₄ continuously applied at a pressure of 6 bar over a period of 1 month.

### Example 3

A flat composite membrane identified as DUR_PB_LI was manufactured as per FIG. 2. A polymeric solution is prepared according to the generating solution of the PB_LI membrane, and diluted in absolute ethanol up to 1% w/w polymer in solution. The solution is inserted into an ultrasound bath for 10 minutes, and then, inserted into a misting device (7) of the airbrush type with a 0.5 mm diameter needle connected to a compressed air line and sprinkled on a commercial polyvinylidene fluoride (PVDF) microfiltration membrane (6), with an average pore size of 0.45 μm, which acts as a support.

The misting conditions are as follows:
a) Applied pressure: 40 psi
b) Distance from the support: about 10 cm
c) Number of misting cycles: 5 cycles
d) Drying time between misting cycles: 10 minutes
f) Drying time under heating: 1 hour
f) Drying time at room temperature: 12 hours.

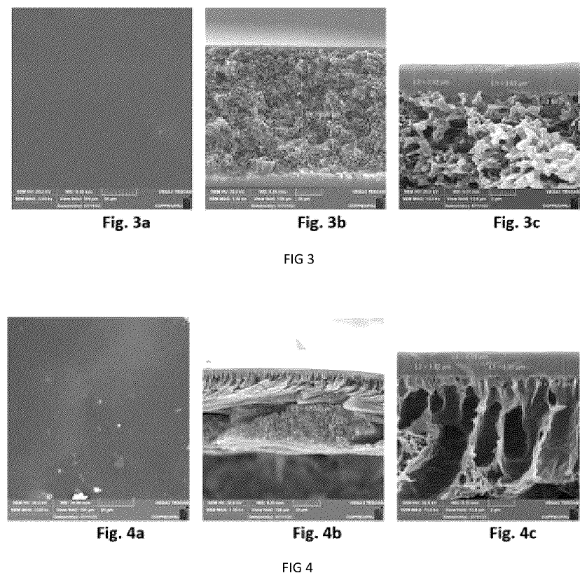

After final drying, a thin layer of silicone elastomer was applied to the membrane surface, to correct any defects present in the selective layer. The morphology of the composite membrane (8) is shown in FIGS. 3a, 3b and 3c. A homogeneous coating of the porous support surface is observed in the region evaluated in FIG. 3a. The cross-section of the porous support containing a thin dense layer on its surface can be seen in FIG. 3b. It is observed in the cross-section at a magnification of approximately 15,000× in FIG. 3c, a dense layer about 2.5 μm thick on the surface of the porous support. The lightest region, 0.56 μm thickness, corresponds to the silicone elastomer layer, and the darkest layer, lower, about 1.9 μm, corresponds to the selective PB_LI layer. 1.9 μm is the value of the difference between the total thickness (2.5 μm) and the thickness of the lightest top layer (0.56 μm).

The permeation test was performed with pure gases at a pressure of 2 bar and with real mixtures of CH₄/CO₂ of composition 50/50% w/w, 70/30% w/w and 93/7% w/w in a high-pressure system (FIG. 5), at a pressure of 30 bar. The membranes showed permeances of 78, 52, 64 and 60 GPU and selectivities of 18, 10, 9 (real) and 16 (ideal) for the amount of CO₂ in the feed of 7, 30, 50 (mixtures) and 100% w/w (pure gas), respectively. The membranes withstood up to a feed pressure of 45 bar without showing modification of their properties. The permeance of the membrane was higher than that of the commercial membrane in all cases, with the exception of the experiment with pure gas, in which the permeances were similar (FIG. 7).

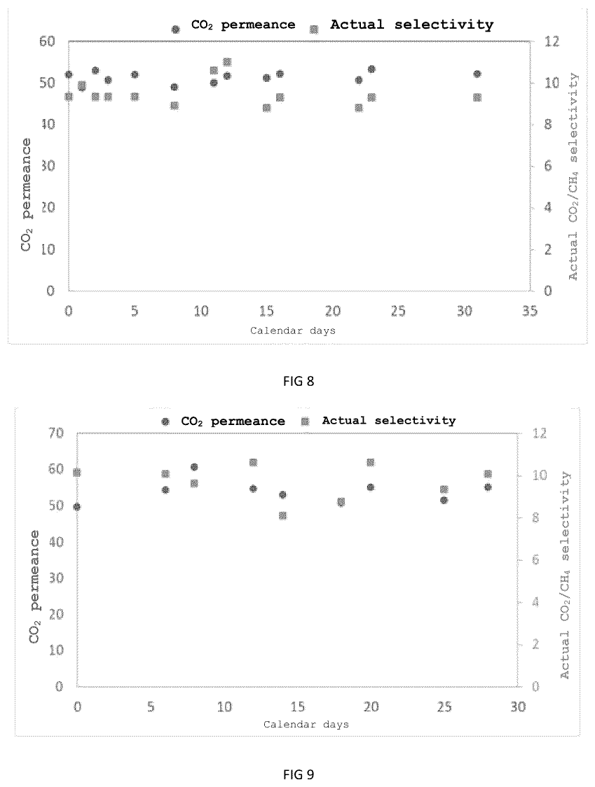

The DUR_PB_LI membrane remained stable during cycles of permeation continuously applied daily at pressures of 10-40 bar of feed, for a mixture with CH₄/CO₂ of 70/30% w/w composition, over a period of 28 days (FIG. 8).

### Example 4

A flat composite membrane identified as PVDF_PB_LI_1 was manufactured as per FIG. 2. A KYNAR 500® PVDF polymer solution was prepared with a PVDF concentration (3a) of 20% w/w in n-methyl-2-pyrrolidone (NMP) solvent at 75% w/w (3b) and with the addition of adipic acid (3c) at a concentration of 5% w/w. The reagents were mixed under mechanical stirring and heating at 60° C. until homogenization of the polymeric solution.

The resulting polymeric solution was inserted in an ultrasound bath for 10 minutes and spread on a glass support with the aid of a 200 μm thick stainless steel extensometer (4). The glass support was immediately immersed in a pure water bath (5) for polymer precipitation. The resulting polymeric membrane (6) was dried and fixed on a support for coating by misting.

The generating solution of the PB_LI membrane was diluted in absolute ethanol up to 0.2% w/w polymer in solution. The solution is inserted into an ultrasound bath for 10 minutes and then into the airbrush (7) and misted onto the PVDF membrane. The misting conditions are as follows:
a) Misting pressure: 30 psi
b) Distance from the support: about 10 cm
c) Number of misting cycles: 6 cycles
d) Drying time between misting cycles: 10 minutes
f) Drying time under heating: 1 hour
f) Drying time at room temperature: 12 hours.

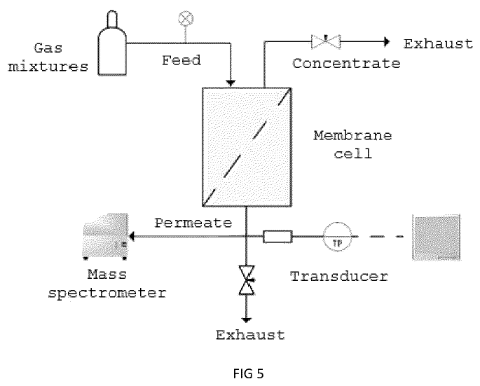

After final drying, a thin layer of silicone elastomer was applied to the membrane surface, to correct any defects present in the selective layer. The morphology of the composite membrane (8) is shown in FIGS. 4a, 4b and 4c. A homogeneous coating of the porous support surface is observed in the region evaluated in FIG. 4a. The cross-section of the porous support containing a thin dense layer on its surface can be seen in FIG. 4b. It is observed in the cross-section at a magnification of approximately 15,000×in FIG. 4c, a dense layer on the porous support surface of about 1.9 μm. The lightest region, 0.31 μm, corresponds to the silicone elastomer layer, and the darkest layer, lower, about 1.6 μm, corresponds to the selective PB_LI layer. 1.6 μm is the value of the difference between the total thickness (1.9 μm) and the thickness of the lightest layer (0.3 μm).

The permeation test was performed with pure gases at a pressure of 2 bar and with real mixtures of CH₄/CO₂ gases of composition 50/50% w/w and 70/30% w/w in a high-pressure system (FIG. 5), at a pressure of 30 bar. The membranes showed permeances of 44, 49 and 63 GPU and selectivities of 17, 16 (real) and 33 (ideal) for the amount of CO₂ in the feed of 30, 50 (mixtures) and 100% w/w (pure gas), respectively. The membranes withstood up to a feed pressure of 45 bar without showing modification of their properties. The permeance of the membrane was higher than that of the commercial membrane in all cases (FIG. 7).

A test was performed with a flat commercial membrane under the same conditions as in examples 3 and 4. It should be noted that composite membranes containing ionic liquid showed superior performances compared to commercial membranes in all compositions of gas mixtures evaluated.

### Example 5

A flat composite membrane identified as PVDF_PB_LI_2 was manufactured as per FIG. 2. A KYNAR 500® PVDF polymeric solution was prepared with a PVDF concentration (3a) of 20% w/w in n-methyl-2-pyrrolidone (NMP) solvent at 75% w/w (3b) and with the addition of adipic acid (3c) at a concentration of 5% w/w. The reagents were mixed under mechanical stirring and heating at 60° C. until homogenization of the polymeric solution.

The resulting polymeric solution was inserted in an ultrasound bath for 10 minutes and spread on a glass support with the aid of a 200 μm thick stainless steel extensometer (4). The glass support was immediately immersed in a pure water bath (5) for polymer precipitation. The resulting polymeric membrane (6) was dried and fixed on a support for coating by misting.

The generating solution of the PB_LI membrane was diluted in absolute ethanol up to 0.2% w/w polymer in solution. The solution is inserted into an ultrasound bath for 10 minutes and then into the airbrush (7) and misted onto the PVDF membrane. The misting conditions are as follows:
a) Misting pressure: 20 psi
b) Distance from the support: about 10 cm
c) Number of misting cycles: 7 cycles
d) Drying time between misting cycles: 10 minutes
f) Drying time under heating: 1 hour
f) Drying time at room temperature: 12 hours.

After final drying, a thin layer of silicone elastomer was applied to the membrane surface, to correct any defects present in the selective layer.

The permeation test was performed with pure gases at 2 bar and with real mixtures of CH₄/CO₂ gases of composition 50/50% w/w and 70/30% w/w in a high-pressure system (FIG. 5), at a pressure of 30 bar. The membranes showed permeances of 49, 59 and 73 GPU and selectivities of 11, 10 (real) and 27 (ideal) for the amount of CO₂ in the feed of 30, 50 (mixtures) and 100% w/w (pure gas), respectively. The membranes withstood up to a feed pressure of 45 bar without showing modification of their properties. The permeance of the membrane was higher than that of the commercial membrane in all cases (FIG. 7).

The PVDF_PB_LI_2 membrane remained stable during cycles of permeation continuously applied daily at pressures of 10-40 bar of feed, for a mixture with CH₄/CO₂ of 70/30% w/w composition, over a period of 28 days (FIG. 9).

A test was performed with a flat commercial membrane under the same conditions as in examples 3, 4 and 5. It should be noted that composite membranes containing ionic liquid showed superior performances compared to commercial membranes in all compositions of gas mixtures evaluated.

### Example 6—Dense PVA_LI membrane

To obtain a dense PVA membrane containing ionic liquid (PVA_LI membrane), the method of the present invention was carried out as follows:
1) 7% w/w polyvinyl alcohol with hydrolysis degree greater than 99% is added to a two-neck flask containing pure water (distilled/microfiltered/deionized) as solvent.
2) The flask is connected to a reflux condenser and immersed in a glycerol bath heated to about 80° C., on a stirring and heating plate; Stirring is applied with the aid of a magnetic bar until the polymer is completely dissolved.
3) After complete dissolution, the heating is decreased so that the temperature of the solution cools down to 60° C.; propionic acid is slowly dripped into the solution up to pH 5.
4) Glutaraldehyde is added to a ratio of 0.8% of the PVA mass, and then, after 10 minutes of stirring, the ionic liquid (IL) [m-2-HEA][Pr] is added in an amount equal to 80% of the PVA mass.
5) The pH is readjusted up to 5 after the addition of the IL, and the stirring has been maintained under reflux conditions for about 1 hour; then, inert gas (N2) is bubbled into the solution to ensure removal of the unreacted acid.
6) The resulting solution is allowed to rest until the bubbles disappear and then poured into a Teflon mold, which is covered and kept in a fume hood at room temperature and pressure until the solvent has completely evaporated, forming the dense membrane.

The membrane obtained comprises, as components, polyvinyl alcohol crosslinked with glutaraldehyde containing 80% polymer mass of the ionic liquid [m-2-HEA][Pr] impregnated in the polymeric matrix.

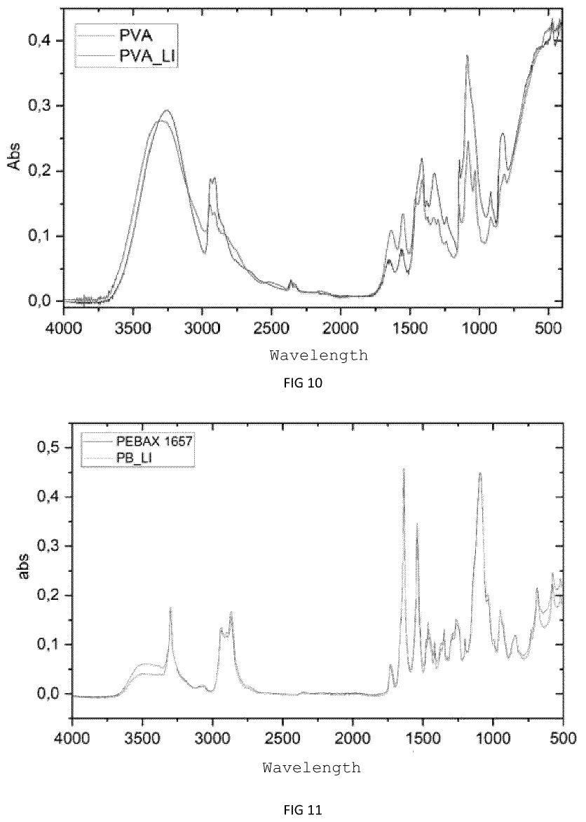

The characterization by Fourier transform infrared spectroscopy (FTIR) of the pure PVA membrane and the membrane PVA_LI containing ionic liquid, obtained by the process according to the present invention, can be seen in FIG. 10. For comparison purposes, the pure PVA membrane is produced from steps 1, 2 and 4 described above.

The characterization of the membranes by FTIR confirms the incorporation of IL. The bands at the wavelength of ˜1600 cm⁻¹ are associated with the combination of the C═O stretch and the N—H vibrations of the [m-2-HEA][Pr] and is also found in pure PVA, due to the non-hydrolyzed carbonyl groups in its synthesis. The increase in band intensity is then related to the presence of IL in the polymeric matrix, for the PVA_LI membrane, compared to the pure PVA membrane.

The presence of IL and the crosslinking reaction with glutaraldehyde is associated with a decrease and widening of the ˜3330 cm⁻¹ band, which corresponds to the overlapping of the N—H stretches (secondary amine), C—H and O—H. The band at 1141 cm⁻¹ of the C—O stretch referring to crystallinity in PV has a lower intensity for the PVA_LI membrane, an effect also associated with the addition of IL and the crosslinking reaction.

### Example 7—Dense PB_LI membrane

To obtain an amide/polyether copolymer membrane containing ionic liquid (PB_LI membrane), according to the process of the present invention, the following steps were carried out.
1) amide/polyether copolymer is added in a two-neck flask containing a mixture of 70% w/w of absolute ethanol and 30% w/w of pure (distilled/microfiltered/deionized)water. The amount of polymer added is 3% w/w relative to the mass of the aqueous solution.
2) The flask is connected to a reflux condenser and immersed in a glycerol bath heated to about 80° C., on a stirring and heating plate; Stirring is applied with the aid
of a magnetic bar until the polymer is completely dissolved. 3) After complete dissolution, the heating is decreased so that the temperature of the solution cools to 70° C., and then the ionic liquid (IL)N-methyl-2-hydroxyethylammonium propionate ([m-2-HEA][Pr]) is added in the amount of 60% of the mass of amide/polyether copolymer, maintaining stirring for about 1 hour.
4) The resulting solution is allowed to rest until the bubbles disappear and then poured into a Teflon mold, which is covered and kept in a fume hood at room temperature and pressure until the solvent has completely evaporated, forming the dense membrane.

For comparison purposes, the pure amide/polyether copolymer membrane is produced following the steps 1, 2, and 4 described above.

The PB_LI membrane obtained comprises, as components, amide/polyether copolymer containing 60% polymer mass of the ionic liquid [m-2-HEA][Pr] impregnated in the polymeric matrix.

The characterization by Fourier transform infrared spectroscopy (FTIR) of the pure amide/polyether copolymer membrane and the membrane PB_LI containing ionic liquid, obtained by the process according to the present invention, can be seen in FIG. 11.

As shown in FIG. 11, the characterization of the membranes by FTIR confirms the incorporation of the IL. The bands at the wavelength of ˜1600 cm⁻¹ are associated with the combination of the C=0 stretch and the N—H vibrations of the [m-2-HEA][Pr] and is also found with great intensity in the pure amide/polyether copolymer, due to the H—N—C═O stretch of the polyamide block. The bands of [m-2-HEA][Pr] are superimposed on those of the amide/polyether copolymer; however, an increase in the band around ˜1600 cm⁻¹ is observed for the PB_LI membrane, associated with the incorporation of IL in the polymeric matrix. The decrease in the O—H band in length ˜3500 cm⁻¹ observed may be related to a possible crosslinking reaction between the amide/polyether copolymer and the IL.

### Example 8—Composite membrane DUR_PB_LI

To obtain a composite membrane of PB_LI, according to the process of the present invention, the following steps were carried out.
1) The polymeric solution produced in step 3 of Example 2 above is diluted in absolute ethanol to a ratio of 1% w/w, and subjected to ultrasound bath for 10 minutes, to remove dissolved air.
2) The polymeric solution is misted with an airbrush with a 0.5 mm diameter needle on a microporous poly(vinylidene fluoride) (PVDF) commercial membrane, fixed on a glass plate; the airbrush is connected to a compressed air line and pressurized up to 40 psi, and the solution is misted at a distance of about 10 cm from the porous support.
3) After misting the membrane extension, the assembly is left to rest in the environment for 10 minutes to allow the selective layer to dry; the misting and drying cycle is repeated 4 more times.
4) At the end of the last misting cycle, the membrane is dried in an oven at 60° C. for a period of 1 hour, and then in a fume hood at room temperature, to ensure the evaporation of the remaining solvent for 12 h.
5) After final drying, a thin layer of silicone elastomer is applied to the surface of the membrane with an airbrush, with 1 spray cycle, to correct any defects present in the selective layer.

The membrane obtained has the following components: commercial PVDF microfiltration membrane covered with an amide/polyether copolymer layer containing 60% by polymer mass of the ionic liquid [m-2-HEA][Pr] impregnated in the polymeric matrix, and an additional layer of silicone elastomer for the protection of the amide/polyether copolymer layer.

### Example 9—Composite PVDF_PB_LI_1 and PVDF_PB_LI_2 Membranes

1) A KYNAR 500® PVDF is added in a Schott vial at a ratio of 20% w/w in N-methyl-2-pyrrolidone (NMP) solvent at 75% w/w, with the addition of adipic acid at a concentration of 5% w/w as an additive.
2) The reagents are mixed under magnetic stirring and heating at 60° C. on a heating plate, until homogenization of the polymeric solution.
3) A small amount of PVDF/NMP/adipic acid solution is poured and spread on a glass plate with the aid of a 200 μm thick stainless steel extensometer, forming a film of the polymeric solution.
4) The “plate-polymeric solution” system is immediately immersed in a container containing pure (distilled/microfiltered/deionized) water, thus causing the polymer to precipitate and generating a porous membrane.
5) The membrane produced is kept in pure water for 24 h, and then subjected to an absolute ethanol bath for 2 h followed by a hexane bath for 30 minutes; finally, the membrane is kept at rest in a fume hood at room temperature for drying.
6) The polymeric solution containing the ionic liquid described in Example 2 above is diluted in absolute ethanol to a ratio of 0.2% w/w and subjected to ultrasound bath for 10 minutes, to remove dissolved air.
7) The polymeric solution is misted with an airbrush with a 0.5 mm diameter needle on the membrane produced in step 5), fixed on a glass plate; the airbrush is connected to a compressed air line and pressurized up to 30 psi for the PVDF_PB_LI_1 membrane, and 20 psi for the PVDF_PB_LI_2 membrane, and the solution is misted at a distance of about 10 cm from the porous support.
8) After misting the membrane extension, the assembly is left to rest in the environment for 10 minutes to allow the selective layer to dry; the misting and drying cycle is repeated 5 more times for the PVDF_PB_LI_1 membrane, and 6 times for the PVDF_PB_LI_2 membrane.
9) At the end of the last misting cycle, the membrane is dried in an oven at 60° C. for a period of 1 hour, and then in a fume hood at room temperature, to ensure the evaporation of the remaining solvent for 12 h.
10) After final drying, a thin layer of silicone elastomer is applied to the membrane surface using an airbrush, with 1 misting cycle, in order to correct any defects present in the selective layer.

The membrane obtained has the following components: PVDF porous membrane covered with an amide/polyether copolymer layer containing 60% by polymer mass of the ionic liquid [m-2-HEA][Pr] impregnated in the polymeric matrix, and an additional layer of silicone elastomer for the protection of the amide/polyether copolymer layer.

### DETAILED DESCRIPTION OF THE FIGURES AND ANALYSIS OF RESULTS

FIG. 1 refers to the production process of PVAR_LI and PB_LI dense flat membranes (images 1.1, 1.2 and 1.3 of FIG. 1) and to the permeation tests on pure gases performed only with these membranes (flowchart represented in the fourth image, 1.4, of FIG. 1). Both membranes use the same preparation and testing apparatus. The apparatuses and materials used are listed in FIG. 1, and are described below:
1a—Polyvinyl alcohol polymer, or PVA
1b—Pebax® MH 1657 grade PEBA polymer (amide/polyether copolymer)
1c—N-methyl-2-hydroxyethylammonium propionate ([m-2-HEA][Pr]) ionic liquid
   i—Reflux condenser
   ii—two-neck flask
   iii—magnetic Bar
   iv—Heating and magnetic stirring plate
   v—glass container with a glycerol bath

FIG. 1 depicts the synthesis apparatus of dense membranes. To prepare the PVAR_LI membrane, 7% w/w PVA (1a) is added to a two-neck flask (ii) containing the solvent (pure water), which is heated under magnetic stirring with the aid of the magnetic bar (iii) and the heating and magnetic stirring plate (iv) until the polymer is completely dissolved. The flask is dipped in a glycerol bath (v) for temperature homogenization. This dissolution occurs under reflux, with the aid of the reflux condenser (i), to prevent evaporation and loss of the solvent to the environment.

Then, propionic acid is added to adjust the pH up to 5 and a crosslinking agent, which can be glutaraldehyde, in a ratio of 0.1% w/w of the polymer mass in the solution. After 10 minutes of reaction, a protic ionic liquid (IL) based on N-methylethanolamine is added, in this case N-methyl-2-hydroxyethylammonium propionate ([m-2-HEA][Pr]) (1c), in a ratio of 80% w/w of the polymer mass in the solution. The pH is readjusted to 5 and stirring is maintained until the end of the reaction for 60 minutes, under reflux conditions. The synthesis of the pure membrane (called PVA) as the basis of comparison is carried out without the addition of the ionic liquid.

To prepare the PB_LI membrane, 3% w/w of Pebax® MH 1657 (amide/polyether copolymer) (1b) is added to a two-neck flask (ii) containing the solvent (mixture of pure water 30% w/w and absolute ethanol 70% w/w), which is heated under magnetic stirring with the aid of the magnetic bar (iii) and the heating and magnetic stirring plate (iv) until the polymer is completely dissolved. The flask is dipped in a glycerol bath (v) for temperature homogenization. This dissolution occurs under reflux, with the aid of the reflux condenser (i), to prevent evaporation and loss of the solvent to the environment.

Then, a protic ionic liquid based on N-methylethanolamine, in this case [m-2-HEA][Pr](1c), is added in a ratio of 60% w/w of the polymer mass in the solution, and stirring is maintained for 60 minutes at room temperature. The synthesis of the pure membrane (called PB) as the basis of comparison is carried out without the addition of the ionic liquid.

To produce both dense membranes PVA_LI and PB_LI, after the completion of the preparation of the solutions, they are kept at rest for a certain time to remove air bubbles, and poured under a coated neutral base for slow evaporation of the solvent and formation of the dense membranes. These procedures are represented by images 1.2 and 1.3 in FIG. 1, and the dense membrane formed is represented by item 2 of FIG. 1.

Finally, the dense membranes are submitted to permeation experiments with pure gases to evaluate their performance, in the system represented by the flowchart depicted in image 1.4 of FIG. 1, in the sequence illustrated in FIG. 1. The gases used in the tests were CO₂ and CH₄, with a purity of 99.99%. In the experiments, the membrane is inserted into a stainless steel permeation cell containing two compartments; the upper one, above the membrane, where the pure gas is fed, and the lower one, below the membrane, where the permeate is collected.

The pure gas is fed into the upper compartment of the permeation cell at a constant pressure and room temperature, and the lower compartment is sealed under room pressure. As the gas permeates the membrane and becomes confined, the pressure in the lower compartment increases, and the variation over time is recorded by a pressure transducer. Data acquisition is performed by a computer. The experiments were carried out under a feed pressure of 6 bar.

To perform the stability tests, the gases CO₂ or CH₄ were continuously applied at a pressure of 6 bar for a period of 1 month, in cycles of about 12 h of permeation for each gas. The permeate accumulated in the lower part of the cell was continuously discarded into the environment.

FIG. 2 illustrates the production process of the flat composite membranes DUR_PB_LI, PVDF_PB_LI_1 and PVDF_PB_LI_2. The composite membrane DUR_PB_LI is produced by misting the polymeric solution that generates the PB_LI membrane, the preparation of which is described in FIG. 1, on a commercial polyvinylidene fluoride (PVDF) microfiltration membrane, with an average pore size of 0.45 μm, which acts as a support for the selective layer.

The apparatuses and materials used are described below:
3—PVDF polymeric solution accommodated in a Schott vial,
4—Spreader of the membrane-forming polymeric solution, on a glass plate,
5—Container with pure water as a precipitation bath, where the glass plate containing the spread polymeric solution is dipped,
6—Porous membrane generated in step 5 fixed on a glass plate for misting and preparation of the composite membrane,
7—Airbrush used in the misting of the polymeric solution of amide/polyether copolymer containing ionic liquid,
8—Composite membrane.

Composite membranes PVDF_PB_LI_1 and PVDF_PB_LI_2 are produced in a similar manner; however, the porous polymeric membrane used as a support is produced in the laboratory. Thus, FIG. 2 describes the complete production process of PVDF_PB_LI_1 and PVDF_PB_LI_2 composite membranes, demonstrating the preparation of the porous membrane used as a support (items 3, 4 and 5) and the misting of the porous support for the production of the composite membrane (items 6, 7 and 8). The composite membrane DUR_PB_LI was prepared by misting the polymeric solution on a commercial porous membrane, and the production process of the latter is described only by the images corresponding to the misting of the membrane (items 6, 7 and 8) in FIG. 2.

For the preparation of the DUR_PB_LI composite membrane, the polymeric solution produced according to the methodology described in FIG. 2 is diluted in absolute ethanol, up to a concentration of 1% w/w of polymer in solution. The solution is inserted into an ultrasound bath for 10 minutes to remove dissolved air, and then inserted into am airbrush misting device (item 7 of FIG. 2) with a 0.5 mm diameter needle, connected to a compressed air line.

The membrane that acts as a support (item 6 of FIG. 2) is fixed to a glass plate. The airbrush (item 7 of FIG. 2) is pressurized to 40 psi and the solution is misted at a distance of about 10 cm from the porous support. Then, the assembly is left to rest in the environment for 10 minutes, to dry the selective layer. This procedure is repeated for another 4 times. At the end of the last misting cycle, the membrane is dried in an oven at 60° C. for a period of 1 hour, and then in a fume hood at room temperature, to ensure the evaporation of the remaining solvent, for 12 h.

To prepare the composite membranes PVDF_PB_LI_1 and PVDF_PB_LI_2, the porous membrane used as a support was first prepared. The porous membrane is produced by the phase inversion technique. This technique consists of inducing phase separation in a homogeneous polymeric solution, which is promoted by immersing the polymeric solution in a non-solvent bath, to modify the equilibrium condition of the polymer/solvent system through its destabilization.

A KYNAR 500® PVDF polymeric solution is prepared with a PVDF concentration of 20% w/w in n-methyl-2-pyrrolidone (NMP) solvent at 75% w/w, and with the addition of adipic acid as an additive, at a concentration of 5% w/w. The reagents are mixed together under magnetic stirring and heating at 60° C., until homogenization of the polymeric solution (item 3 of FIG. 2). Then, a small amount of the solution is poured and spread on a glass plate with the aid of a 200 μm thick stainless steel extensometer (item 4 of FIG. 2), forming a film of the polymeric solution. This “plate-polymeric solution” system is immersed in a container containing pure water (item 5 of FIG. 2), which acts as a non-solvent bath, thus causing the polymer to precipitate and generating the porous membrane.

The porous membrane is then fixed to a glass plate, acting as a support (item 6 of FIG. 2) for the production of composite membranes. For the preparation of the PVDF_PB_LI_1 and PVDF_PB_LI_2 composite membranes, the polymeric solution produced according to the methodology described in FIG. 1 is diluted in absolute ethanol, up to a concentration of 0.2% w/w of polymer in solution. The solution is inserted into an ultrasound bath for 10 minutes to remove dissolved air, and then inserted into am airbrush misting device (item 7) with a 0.5 mm diameter needle, connected to a compressed air line.

For the PVDF_PB_LI_1 membrane, the airbrush is pressurized to 30 psi and the solution is misted at a distance of about 10 cm from the porous support. Then, the assembly is left to rest in the environment for 10 minutes, to dry the selective layer. This procedure is repeated for another 5 times. For the PVDF_PB_LI_2 membrane, the airbrush is pressurized to 20 psi and the solution is misted at a distance of about 10 cm from the porous support. Then, the assembly is left to rest in the environment for 10 minutes, to dry the selective layer. This procedure is repeated for another 6 times.

At the end of the last misting cycle, both membranes are dried in an oven at 60° C. for a period of 1 hour, and then in a fume hood at room temperature, to ensure the evaporation of the remaining solvent, for 12 h.

After the final drying of the three composite membranes DUR_PB_LI, PVDF_PB_LI_1 and PVDF_PB_LI_2 described, a thin layer of silicone elastomer is applied to the surface of the membranes with an airbrush (item 7 of FIG. 2), in order to correct any defects present in the selective layer. Item 8 of FIG. 2 is a visual representation of the morphology of the composite membranes obtained at the end of the production process.

FIG. 3 shows the characterization of the morphology of the DUR_PB_LI composite membrane in surface micrographs (Photo 3A of FIG. 3) and in cross-section (Photos 3B and 3C of FIG. 3), conducted using scanning electron microscopy. FIG. 3a shows the homogeneous coating of the porous support surface with the dense polymeric solution of PB_LI, at a 2,000-fold magnification. FIG. 3b shows the cross-section of the composite membrane at a 1,500-fold magnification.

It is possible to observe the porous support containing a thin dense layer on its surface, which is the selective dense layer produced by the misting procedure. It is observed in the cross-section at a magnification of approximately 15,000×in FIG. 3c. The dense layer on the surface of the porous support, which has a thickness of approximately 2.5 μm, is more clearly visible. The lighter region of 0.56 μm corresponds to the silicone elastomer layer, while the darker lower layer of about 1.9 μm corresponds to the selective PB_LI layer. 1.9 μm is the value of the difference between the total thickness (2.5 μm) and the thickness of the lightest top layer (0.56 μm).

FIG. 4 shows the characterization of the morphology of the PVDF_PB_LI_1 composite membrane in surface photomicrographs (Photo 4A) and the cross-section (Photos 4B and 4C) of the membrane, conducted using scanning electron microscopy. FIG. 4a shows the homogeneous coating of the porous support surface with the dense polymeric solution of PB_LI, at a 2,000-fold magnification. FIG. 4b shows the cross-section of the composite membrane at a 1,500-fold magnification.

It is possible to observe the porous support containing a thin dense layer on its surface, which is the selective dense layer produced by the misting procedure. The cross-section is observed at a magnification of approximately 15,000×in FIG. 4c. The dense layer on the surface of the porous support, which has a thickness of approximately 1.9 μm, is more clearly visible. The lightest region, 0.31 μm, corresponds to the silicone elastomer layer, and the darkest layer, lower, about 1.6 μm, corresponds to the selective PB_LI layer. 1.6 μm is the value of the difference between the total thickness (1.9 μm) and the thickness of the lightest top layer (0.31 μm).

FIG. 5 shows the flowchart of the high pressure system used for permeation tests with gas mixtures, used to evaluate the performance of composite membranes DUR_PB_LI, PVDF_PB_LI_1 and PVDF_PB_LI_2.

The apparatuses and materials used were listed in the image, and are described below:
Cylinder containing the gas mixture used to feed the system
Gauge for feed pressure control
Permeation cell
Concentrate outlet valve (exhaust)
Permeate outlet valve (exhaust)
Pressure transducer
Computer

The high pressure system works in a similar way to the benchtop system described in FIG. 1. The gas mixture is fed into the upper compartment of the permeation cell at a constant pressure and room temperature, and the lower compartment is sealed under room pressure. As the gas mixture permeates the membrane and becomes confined, the pressure in the lower compartment increases, and the variation over time is recorded by a pressure transducer. Data acquisition is performed by a computer.

However, the permeate outlet in the membrane containing cell of the high-pressure system is directly connected to a mass spectrometer. The equipment performs the analysis of the permeate composition. From the partial pressure of each gas in the feed and in the composition obtained by the mass spectrometer, it is possible to determine the (real) selectivity of the tested membrane for the mixture.

Different gas mixtures were used in the feed in the experiments. Mixtures containing 50% CO₂/50% CH₄ w/w and 30% CO₂/70% CH₄ w/w were used. The feed pressures ranged from 10 to 40 bar.

FIG. 6 shows the results of the permeation experiments with pure gases CO₂ and CH₄ at a pressure of 6 bar, for the PVA and PB membranes, corresponding to the pure polymers of PVA and amide/polyether copolymer, and for the membranes produced with the addition of the ionic liquid (IL) [m-2-HEA][Pr] PVAR_LI and PB_LI. The tests were performed on the system described in FIG. 1.

The graph in FIG. 6 shows a comparison of the performance of the membranes produced with the addition of the ionic liquid (PVAR_LI and PB_LI) in relation to the performance of the pure polymers (PVA and PB).

The PVAR_LI membrane showed a permeability of about 55 barrer and optimal selectivity CO₂/CH₄ of 44, much higher than the transport properties of pure polymer PVA, which did not show permeation for either gas (permeability =0 barrer; barrier properties).

The PB_LI membrane showed a permeability of about 143 barrer and optimal selectivity CO₂/CH₄ of 32, much higher than the transport properties of pure polymer (PB), whose permeability was 87 and optimal selectivity CO₂/CH₄ of 27. The addition of IL generated a 64% increase in permeability and a 19% increase in pure polymer selectivity.

The results described show that the addition of IL to the polymers resulted in a substantial increase in the permeability to CO₂ compared to pure polymers, without sacrificing selectivity, which proves the beneficial effect of the additive.

FIG. 7 shows a comparison of the performance of the different composite membranes produced DUR_PB_LI, PVDF_PB_LI_1 and PVDF_PB_LI_2, compared to the performance of a commercial membrane, in the separation of gas mixtures of CO₂/CH₄ containing different ratios of gases, at a mixture feed pressure of 30 bar. The results corresponding to pure gas (100% CO₂) were performed at a pressure of 2 bar. The experiments were carried out in the high pressure system described in FIG. 6 for the gas mixtures and in the benchtop system described in FIG. 1 for the pure gas. Performance is shown in terms of permeance to CO₂ and actual selectivity of CO₂/CH₄.

The DUR_PB_LI membrane showed permeances of 78, 52, 64 and 60 GPU and selectivities of 18, 10, 9 (real) and 16 (ideal) for the amount of CO₂ in the feed of 7, 30, 50 (mixtures) and 100% w/w (pure gas), respectively. The PVDF_PB_LI_1 membrane showed permeances of 44, 49 and 63 GPU and selectivities of 17, 16 (real) and 33 (ideal) for the amount of CO₂ in the feed of 30, 50 (mixtures) and 100% w/w (pure gas), respectively. The PVDF_PB_LI_2 membrane showed permeances of 49, 59 and 73 GPU and selectivities of 11, 10 (real) and 27 (ideal) for the amount of CO₂ in the feed of 30, 50 (mixtures) and 100% w/w (pure gas), respectively.

It is possible to observe that all the composite membranes produced presented permeances higher than those of the commercial membrane in the experiments with gas mixtures, for all the compositions evaluated. In an experiment containing a high concentration of CH₄ (7% of CO₂), the DUR_PB_LI membrane showed a tendency to increased permeance, with a much higher result than that of the commercial membrane. The results show that there is a tendency to increase the permeance of CO₂ in the compositions between 50 and 100% as the amount of CO₂ in the mixture increases, a behavior also observed for the commercial membrane.

These results indicate that the polymeric solutions developed and the techniques used were both efficient for the production of composite membranes with competitive performance in the separation of mixtures of CO₂/CH₄. Both the production of composite membranes from a commercial support (DUR_PB_LI) and those made from a produced support (PVDF_PB_LI_1 and 2) presented competitive performances.

Changing the parameters allows to generate membranes with slightly different performances. The PVDF_PB_LI_1 membrane showed permeances closer to that of the commercial membrane and lower than that of the other two membranes produced, but exhibited superior selectivities. The results demonstrate the efficiency of the misting technique in the production of composite membranes, as well as its flexibility, since it is possible to obtain competitive performances with different supports and misting parameters.

FIGS. 8 and 9 show the results of permeance to CO₂ and actual CO₂/CH₄ selectivity from the lifespan experiments conducted with continuous permeation for the DUR_PB_LI and PVDF_PB_LI_2 membranes, respectively, in the high pressure system illustrated in FIG. 5.

In these experiments, the mixture CO₂/CH₄ with a ratio of 70/30% w/w was fed at a continuous pressure of 10 bar. In some periods, the pressure was increased to 40 bar, in order to obtain data for measuring the actual permeance and selectivity. At the end of the data acquisition, the feed pressure was again lowered to 10 bar. During the continuous permeation time, there was no accumulation of permeate or concentrate in the system, and both were released into the environment.

It is possible to observe in the graphs that, during the period evaluated, the results of actual permeance and selectivity showed little variation, which is probably the result of the intrinsic standard deviation of the analysis itself. The performance of both membranes remained practically similar to that exhibited in the initial experiments.

This experiment demonstrates that, during a total time of 1 month, the composite membranes produced by the misting technique on two different supports with the PB_LI solution showed stability compared to the use in the separation of a gas mixture with a ratio of 70/30 CH₄/CO₂, at pressures ranging from 10 to 40 bar. This result is extremely important, since it demonstrates a trend towards a long membrane lifespan, essential to enable its use in industrial systems.

In some examples, the present disclosure may involve one or more of the following clauses:

Clause 1. A process for the preparation of a flat dense polymeric membrane containing one or more ionic liquids and their derivatives for sequestration of CO₂ from natural gas by gaseous permeation, comprising the steps of:
(a) dissolution of a polymer (1a, 1b) in a suitable solvent to form a polymeric solution;
(b) addition of a protic ionic liquid (IL) (1c) based on N-methylethanolamine (NMEA) to the polymeric solution; and
(c) production of the flat dense polymeric membrane generated from controlled evaporation of the solvent from the polymeric solution in a container made of inert material, and evaluation of the transport properties of the polymer and the effect of the addition of IL.

Clause 2. A process for the preparation of a polymeric, asymmetric flat composite membrane containing one or more ionic liquids and their derivatives for sequestration of CO₂ from natural gas by gaseous permeation, comprising the steps of:
(a) dissolution of a polymer (1a, 1b) in a suitable solvent to form a polymeric solution;
(b) addition of a protic ionic liquid (IL) (1c) based on N-methylethanolamine (NMEA)to the polymeric solution; (c) dissolution of the polymeric solution produced in step (b) to a range between 0.2 and 1% w/w of polymer mass in the solution, and removal of the air dissolved in the solution by ultrasound;
(d) dissolution of a second polymer to form a solution containing the second polymer, followed by spreading the solution containing the second polymer with an extensometer on a glass support and subsequent immersion in a non-solvent bath for polymer precipitation to produce a porous membrane for use as a support for the polymeric solution containing IL;
(e) addition of the polymeric solution obtained in step (c) to a pressurized apparatus capable of generating membranes, followed by pressurization in a range of 20-40 psi on a porous polymeric support to produce the composite membrane, wherein the porous polymeric support can be a commercial membrane or the membrane produced in step (d); and
(f) coating of one or more selective layers of the composite membrane with a solution of a super permeable silicone elastomeric polymer in order to cover any defects and promote the protection of the composite membrane for manipulation.

Clause 3. The process according to clause 1, further comprising step (b′) after the addition of the protic ionic liquid (1c), in which one or more additives are added to promote the crosslinking reaction of the polymer (1a).

Clause 4. The process according to clause 1, wherein the polymer (1a) is selected from polyvinyl alcohol (PVA), polyvinylidene fluoride (PVDF), or their derivatives, and wherein the polymer (1a) is aggregated with glutaraldehyde.

Clause 5. The process according to clause 1, wherein the polymer (1b) is selected from amide/polyether copolymers (PEBA) or their derivatives.

Clause 6. The process according to clause 1, wherein in step (a), the solvent used is in the range of 3-7% w/w.

Clause 7. The process according to clause 1, wherein the NMEA-based protic ionic liquid is N-methyl-2-hydroxyethylammonium propionate ([m-2-HEA][Pr]).

Clause 8. The process according to clause 1, wherein in step (b), the protic ionic liquid (IL) (1c) based on NMEA is added in an amount ranging from 60 to 80% w/w of the polymer mass in the solution.

Clause 9. The process according to clause 2, further comprising step (b′) after the addition of the protic ionic liquid (1c), in which one or more additives are added to promote the crosslinking reaction of the polymer (1a).

Clause 10. The process according to clause 2, wherein the polymer (1a) is selected from polyvinyl alcohol (PVA), polyvinylidene fluoride (PVDF), or their derivatives, and wherein the polymer (1a) is aggregated with glutaraldehyde.

Clause 11. The process according to clause 2, wherein the polymer (1b) is selected from amide/polyether copolymers (PEBA) or their derivatives.

Clause 12. The process according to clause 2, wherein in step (a), the solvent used is in the range of 3-7% w/w.

Clause 13. The process according to clause 2, wherein the NMEA-based protic ionic liquid is N-methyl-2-hydroxyethylammonium propionate ([m-2-HEA][Pr]).

Clause 14. The process according to clause 2, wherein in step (b), the protic ionic liquid (IL) (1c) based on NMEA is added in an amount ranging from 60 to 80% w/w of the polymer mass in the solution.

Clause 15. A polymeric membrane obtained by the process as defined in clause 1, wherein the polymeric membrane is a flat dense membrane comprising glutaraldehyde-cross-linked polyvinyl alcohol, and wherein the membrane contains the ionic liquid [m-2-HEA][Pr] in an amount of 80% of polymer mass impregnated in the polymer matrix.

Clause 16. A polymeric membrane obtained by the process as defined in clause 1, wherein the polymeric membrane is a flat dense membrane comprising amide/polyether copolymer, and wherein the membrane contains the ionic liquid [m-2-HEA][Pr] in an amount of 60% of polymer mass impregnated in the polymeric matrix.

Clause 17. A polymeric membrane obtained by the process as defined in clause 2, wherein the polymeric membrane is an asymmetric flat composite membrane comprising a commercial microfiltration PVDF membrane coated with an amide/polyether copolymer layer, and wherein the membrane contains the ionic liquid [m-2-HEA][Pr] in an amount of 60% of polymer mass impregnated in the polymeric matrix, and an additional layer of silicone elastomer for the protection of the amide/polyether copolymer layer.

Clause 18. A polymeric membrane obtained by the process as defined in clause 2, wherein the polymeric membrane is an asymmetric flat composite membrane comprising a PVDF porous membrane coated with an amide/polyether copolymer layer, wherein the membrane contains the ionic liquid [m-2-HEA][Pr] impregnated in an amount of 60% of polymer mass in the polymeric matrix, and an additional layer of silicone elastomer for the protection of the amide/polyether copolymer layer.

1. A process for the preparation of a flat dense polymeric membrane containing one or more ionic liquids and their derivatives for sequestration of CO₂ from natural gas by gaseous permeation, comprising the steps of:
(a) dissolution of a polymer (1a, 1b) in a suitable solvent to form a polymeric solution;
(b) addition of a protic ionic liquid (IL) (1c) based on N-methylethanolamine (NMEA) to the polymeric solution; and
(c) production of the flat dense polymeric membrane generated from controlled evaporation of the solvent from the polymeric solution in a container made of inert material, and evaluation of the transport properties of the polymer and the effect of the addition of IL.

2. A process for the preparation of a polymeric,
asymmetric flat composite membrane containing one or more ionic liquids and their derivatives for sequestration of CO₂ from natural gas by gaseous permeation, comprising the steps of:
(a) dissolution of a polymer (1a, 1b) in a suitable solvent to form a polymeric solution;
(b) addition of a protic ionic liquid (IL) (1c) based on N-methylethanolamine (NMEA)to the polymeric solution;
(c) dissolution of the polymeric solution produced in step (b) to a range between 0.2 and 1% w/w of polymer mass in the solution, and removal of the air dissolved in the solution by ultrasound;
(d) dissolution of a second polymer to form a solution containing the second polymer, followed by spreading the solution containing the second polymer with an extensometer on a glass support and subsequent immersion in a non-solvent bath for polymer precipitation to produce a porous membrane for use as a support for the polymeric solution containing IL;
(e) addition of the polymeric solution obtained in step (c) to a pressurized apparatus capable of generating membranes, followed by pressurization in a range of 20-40 psi on a porous polymeric support to produce the composite membrane, wherein the porous polymeric support can be a commercial membrane or the membrane produced in step (d); and
(f) coating of one or more selective layers of the composite membrane with a solution of a super permeable silicone elastomeric polymer in order to cover any defects and promote the protection of the composite membrane for manipulation.

3. The process according to claim 1, further comprising step (b′) after the addition of the protic ionic liquid (1c), in which one or more additives are added to promote the crosslinking reaction of the polymer (1a).

4. The process according to claim 1, wherein the polymer (1a) is selected from polyvinyl alcohol (PVA), polyvinylidene fluoride (PVDF), or their derivatives, and wherein the polymer (1a) is aggregated with glutaraldehyde.

5. The process according to claim 1, wherein the polymer (1b) is selected from amide/polyether copolymers (PEBA) or their derivatives.

6. The process according to claim 1, wherein in step (a), the solvent used is in the range of 3-7% w/w.

7. The process according to claim 1, wherein the NMEA-based protic ionic liquid is N-methyl-2-hydroxyethylammonium propionate ([m-2-HEA][Pr]).

8. The process according to claim 1, wherein in step (b), the protic ionic liquid (IL) (1c) based on NMEA is added in an amount ranging from 60 to 80% w/w of the polymer mass in the solution.

9. The process according to claim 2, further comprising step (b′) after the addition of the protic ionic liquid (1c), in which one or more additives are added to promote the crosslinking reaction of the polymer (1a).

10. The process according to claim 2, wherein the polymer (1a) is selected from polyvinyl alcohol (PVA), polyvinylidene fluoride (PVDF), or their derivatives, and wherein the polymer (1a) is aggregated with glutaraldehyde.

11. The process according to claim 2, wherein the polymer (1b) is selected from amide/polyether copolymers (PEBA) or their derivatives.

12. The process according to claim 2, wherein in step (a), the solvent used is in the range of 3-7% w/w.

13. The process according to claim 2, wherein the NMEA-based protic ionic liquid is N-methyl-2-hydroxyethylammonium propionate ([m-2-HEA][Pr]).

14. The process according to claim 2, wherein in step (b), the protic ionic liquid (IL) (1c) based on NMEA is added in an amount ranging from 60 to 80% w/w of the polymer mass in the solution.

15. A polymeric membrane obtained by the process as defined in claim 1, wherein the polymeric membrane is a flat dense membrane comprising glutaraldehyde-cross-linked polyvinyl alcohol, and wherein the membrane contains the ionic liquid [m-2-HEA][Pr] in an amount of 80% of polymer mass impregnated in the polymer matrix.

16. A polymeric membrane obtained by the process as defined in claim 1, wherein the polymeric membrane is a flat dense membrane comprising amide/polyether copolymer, and wherein the membrane contains the ionic liquid [m-2-HEA][Pr] in an amount of 60% of polymer mass impregnated in the polymeric matrix.

17. A polymeric membrane obtained by the process as defined in claim 2, wherein the polymeric membrane is an asymmetric flat composite membrane comprising a commercial microfiltration PVDF membrane coated with an amide/polyether copolymer layer, and wherein the membrane contains the ionic liquid [m-2-HEA][Pr] in an amount of 60% of polymer mass impregnated in the polymeric matrix, and an additional layer of silicone elastomer for the protection of the amide/polyether copolymer layer.

18. A polymeric membrane obtained by the process as defined in claim 2, wherein the polymeric membrane is an asymmetric flat composite membranecomprising a PVDF porous membrane coated with an amide/polyether copolymer layer, wherein the membrane contains the ionic liquid [m-2-HEA][Pr] impregnated in an amount of 60% of polymer mass in the polymeric matrix, and an additional layer of silicone elastomer for the protection of the amide/polyether copolymer layer.
